(19) United States
(12) Patent Application Publication
(10) Pub. No.: US 2016/0129470 A1
(43) Pub. Date: May 12, 2016

(54) COATING APPARATUS AND COATING METHOD

(71) Applicant: TOYOTA JIDOSHA KABUSHIKI KAISHA, Toyota-shi, Aichi-ken (JP)

(72) Inventor: Hideyuki TADA, Toyota-shi (JP)

(73) Assignee: TOYOTA JIDOSHA KABUSHIKI KAISHA, Toyota-shi, Aichi-ken (JP)

(21) Appl. No.: 14/900,689

(22) PCT Filed: Jun. 17, 2014
(86) PCT No.: PCT/IB2014/001086

§ 371 Date: Dec. 22, 2015

(30) Foreign Application Priority Data
Jul. 8, 2013 (JP) 2013-142630

(51) Int. Cl. B05C 11/00; B05D 1/26; B05C 5/02

(52) U.S. Cl. CPC B05C 11/00; B05C 5/0225; B05D 1/26

(57) ABSTRACT

In a coating apparatus, which coats an object to be coated with a viscous coating material while causing a moving part to move a flat nozzle that discharges the coating material, the nozzle includes a cylinder that applies predetermined pressing force F to the nozzle towards the object to be coated. The cylinder forms a gap (G) between the object to be coated and the nozzle by moving the nozzle in a direction away from the object to be coated to a position where discharge reaction force (R) is balanced with pressing force (F). The discharge reaction force (R) is generated when the nozzle discharges the coating material to the object to be coated.

### BACKGROUND OF THE INVENTION

1. Field of the Invention

The invention relates to a coating apparatus and a coating method, by which a viscous coating material is discharged from a nozzle and coated on an object to be coated. The invention particularly relates to coating with a high-viscosity coating material.

2. Description of Related Art

Typically, screen printing is used for coating in a case where an object to be coated is coated with a viscous coating material thinly and widely. This applies to, for example, a case where a surface of a power element module is coated with thermal grease thinly and widely. However, in screen printing, there is a possibility that wasteful coating material may be generated. In a case of an expensive coating material like thermal grease in particular, there are demands to reduce an amount of wasteful thermal grease. In screen printing, cleaning is required on a regular basis, and a yield is low. Also, since the number of processes is large, there is a possibility of an increase in costs of equipment.

Thus, in order to eliminate wasteful coating material, discharging a coating material from a nozzle to coat an object to be coated is considered. A coating apparatus for coating an object to be coated with a coating material thinly and uniformly is disclosed in Japanese Patent Application Publication No. 09-253551 (JP 09-253551 A). The coating apparatus disclosed in JP 09-253551 A is a coating apparatus for a viscous coating material that is coated on an object to be coated by discharging the viscous coating material from a nozzle by applying pressure on the viscous coating material. In the coating apparatus, a roller is brought into contact with a surface to be coated by a spring. When the object to be coated is uneven, the spring is bent due to the unevenness, and the roller and the nozzle operate together. Thus, it is possible to uniformly coat an object to be coated with a viscous coating material.

A coating apparatus for coating an object to be coated with a coating material widely, thinly, and uniformly is disclosed in Japanese Patent Application Publication No. 2012-239930 (JP 2012-239930 A). In the coating apparatus disclosed in JP 2012-239930 A, a coating material is fed to a wide groove (a coating part) through a plurality of small tubes. Since the coating material passes through the small tubes, expands in the groove part, and then is discharged to the object to be coated, the object to be coated is coated with the coating material widely and uniformly.

However, as described in JP 09-253551 A, when a nozzle has a function for scanning the unevenness while in contact with an object to be coated, there is a possibility that the coating apparatus becomes large and complex. When the coating apparatus is large and complex, decrease in reliability and durability, and an increase in cost of equipment might happen.

In the technology described in JP 2012-239930 A, in a case of a viscous coating material (especially a high-viscosity coating material), resistance inside the small tubes is large, and diffusivity of the coating material from the small tubes to the groove part is low. Therefore, there is a possible difficulty to achieve uniform expansion of the coating material in the groove part. As a result, the coating material discharged from the nozzle does not become a wide thin film, and can cause coating defects such as sagging and poor opacity.

### SUMMARY OF THE INVENTION

Therefore, the invention provides a coating apparatus and a coating method, by which an object to be coated is coated with a high-viscosity coating material widely, thinly, and uniformly with a small-sized and simple structure.

An aspect of the invention is a coating apparatus that coats an object to be coated with a viscous coating material while a moving mechanism moves a flat nozzle that pressing mechanism that applies predetermined pressing force to the nozzle towards the object to be coated. The pressing mechanism forms a gap between the object to be coated and the nozzle by moving the nozzle in a direction away from the object to be coated to a position where force, which presses the nozzle back to the pressing mechanism by using discharge reaction force, is balanced with the pressing force. The discharge reaction force is generated when the coating material is discharged from the nozzle to the object to be coated. A spring, a cylinder, and so on may be used as the pressing mechanism.

In this coating apparatus, while the pressing mechanism is applying the predetermined pressing force to the nozzle towards the object to be coated, the nozzle discharges and applies the coating material to the object to be coated. The discharge reaction force is generated when the coating material is discharged from the nozzle to the object to be coated. When the discharge reaction force is larger than the pressing force of the pressing mechanism, the nozzle is pressed back towards the pressing mechanism. Then, the nozzle is moved in the direction away from the object to be coated to a position where the discharge reaction force and the pressing force are balanced with each other, and a fixed gap is formed between the object to be coated and the nozzle. By moving the nozzle in a state where the gap is formed, a scraper effect of the nozzle is obtained effectively. As a result, it is possible to coat the object to be coated with a high-viscosity coating material widely, thinly, and uniformly regardless of waviness of a surface to be coated of the object to be coated.

Instead of giving the nozzle a function of scanning an uneven surface while in contact with an object to be coated as stated in a related art, the pressing mechanism having a very simple structure is provided in the nozzle. Therefore, a coating apparatus is realized, by which the object to be coated is coated with a high-viscosity thermal grease widely, thinly, and uniformly, by a small-sized and simple structure.

The coating material used in the coating apparatus according to the aspect of the invention is a high-viscosity coating material (for example, thermal grease). Specifically, the viscosity is 150 Pa·s or higher, 200 Pa·s or higher, or about 250˜500 Pa·s. In short, the coating apparatus according to the aspect of the invention may be used for coating with a high-viscosity coating material.

The above-mentioned coating apparatus may include a control device that controls a feed rate of the coating material to the nozzle and moving speed of the nozzle. The control device may set a size of the gap by controlling at least one of the feed rate and the moving speed.

With such a structure, the size of the gap formed between the object to be coated and the nozzle is changed easily. To be specific, the gap formed between the object to be coated and the nozzle becomes large by increasing the feed rate of the coating material to the nozzle, thereby increasing a film thickness of the coating. On the contrary, the gap formed between the object to be coated and the nozzle becomes small by reducing the feed rate of the coating material to the nozzle, thereby reducing the film thickness of the coating. Similarly, the gap formed between the object to be coated and the nozzle becomes large by reducing the moving speed of the nozzle, thereby increasing the film thickness. The gap formed between the object to be coated and the nozzle becomes small by increasing the moving speed of the nozzle, thereby reducing the film thickness. By deciding appropriate feed rate and moving speed (coating speed) in advance based on experiments and so on, it is possible to set an appropriate gap between the object to be coated and the nozzle in accordance with the coating material to be used. It is thus possible to coat the object to be coated with the high-viscosity coating material uniformly with a desired film thickness.

It is also possible to adjust the size of the gap formed between the object to be coated and the nozzle by changing an opening area of the nozzle (changing an opening height (gap) of the nozzle because an opening width of the nozzle basically matches the width of the object to be coated). Therefore, the opening area of the nozzle may be changed in addition to changing at least one of the feed rate and the moving speed. In a case where the opening area of the nozzle is changed, the gap formed between the object to be coated and the nozzle becomes large by increasing the opening area, thereby increasing the film thickness, and the gap formed between the object to be coated and the nozzle becomes small by reducing the opening area, thereby reducing the film thickness.

Alternatively, it is also possible to adjust the size of the gap formed between the object to be coated and the nozzle by changing pressing force of the pressing mechanism. Therefore, the pressing force of the pressing mechanism may be changed (or controlled where necessary) in addition to controlling at least one of the feed rate and the moving speed. In a case where the pressing force of the pressing mechanism is changed, the gap formed between the object to be coated and the nozzle becomes large by reducing the pressing force, thereby increasing the film thickness, and the gap formed between the object to be coated and the nozzle becomes small by increasing the pressing force, thereby reducing the film thickness.

In the above-mentioned coating apparatus, a discharge port of the nozzle may be formed so that a throttle length of both end parts of the nozzle becomes shorter than a throttle length of a center part of the nozzle in order to realize uniform discharge pressure of the coating material discharged from the discharge port.

Since the discharge port of the nozzle has a flat, long, and narrow shape, a pressure drop in both end parts of the nozzle becomes larger than a pressure drop in the center part of the nozzle, when the viscous coating material is discharged from the nozzle. Therefore, a discharge quantity in the center part of the nozzle is large, and a discharge quantity in both end parts of the nozzle is small. This means that uniform discharge of thermal grease in the entire region of the width of the nozzle may not be possible.

Thus, as stated above, the shape of the discharge port of the nozzle is formed so that the throttle length of both end parts of the nozzle becomes shorter than the throttle length of the center part of the nozzle. This way, the pressure drop in both end parts of the nozzle is reduced. As a result, the nozzle is able to discharge the coating, material stably and uniformly in a width direction.

Another aspect of the invention is a coating method in which an object to be coated is coated with a viscous coating material while a moving mechanism moves a applying predetermined pressing force to the nozzle towards the object to be coated, a gap is formed between the object to be coated and the nozzle by moving the nozzle in a direction away from the object to be coated to a position where force, which presses the nozzle back by using discharge reaction force, is balanced with the pressing force. The discharge reaction force is generated when the nozzle discharges the coating material to the object to be coated.

In this coating method, the coating material is discharge from the nozzle while applying the predetermined pressing force to the nozzle towards the object to be coated. Thus, the nozzle is moved in the direction away from the object to be coated to the position where the force that presses the nozzle back by using the discharge reaction force is balance with the pressing force, and a fixed gap is formed between the object to be coated and the nozzle. By moving the nozzle in the state where the gap is formed, a scraper effect of the nozzle is obtained effectively. Thus, it is possible to coat the object to be coated with a high-viscosity coating material widely, thinly, and uniformly regardless of waviness of a surface to be coated of the object to be coated.

As stated so far, according to the coating apparatus and the coating method of the invention, an object to be coated is coated with a high-viscosity coating material widely, thinly, and uniformly by a small-sized and simple structure.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing a rough structure of a coating apparatus according to an embodiment;

FIG. 2 is a view roughly showing a coating nozzle and explaining a principle of a coating method;

FIG. 3 is a view showing an internal shape of the coating nozzle;

FIG. 5 is a sectional view of both end parts of the coating nozzle;

FIG. 6 is a perspective view roughly showing a work holding part provided in the coating apparatus;

FIG. 7 is a graph showing variation in film thickness; and

FIG. 8 is a view schematically showing a rough structure of a coating apparatus according to a modified example.

### DETAILED DESCRIPTION OF EMBODIMENTS

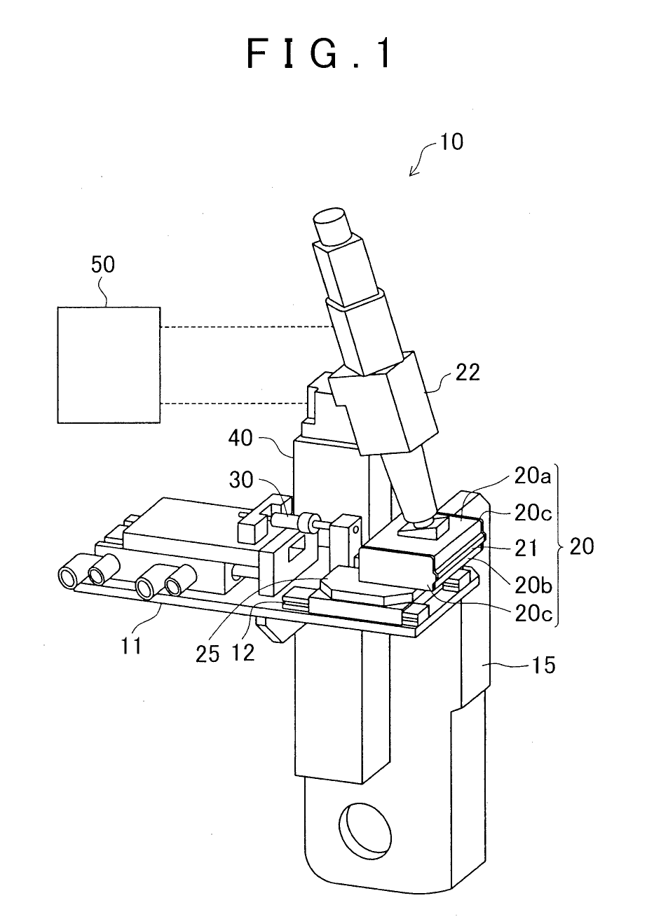

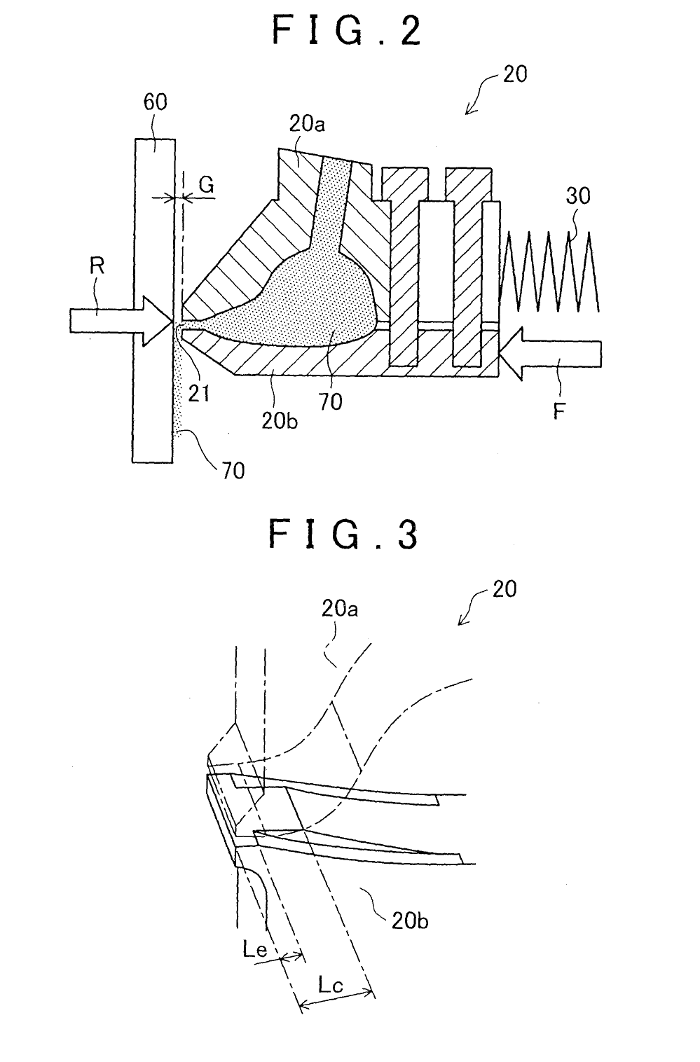

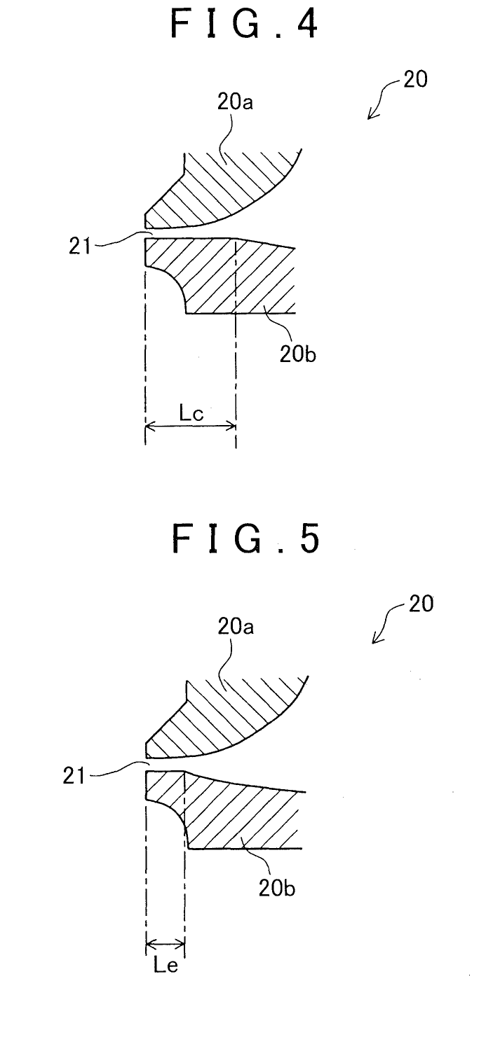

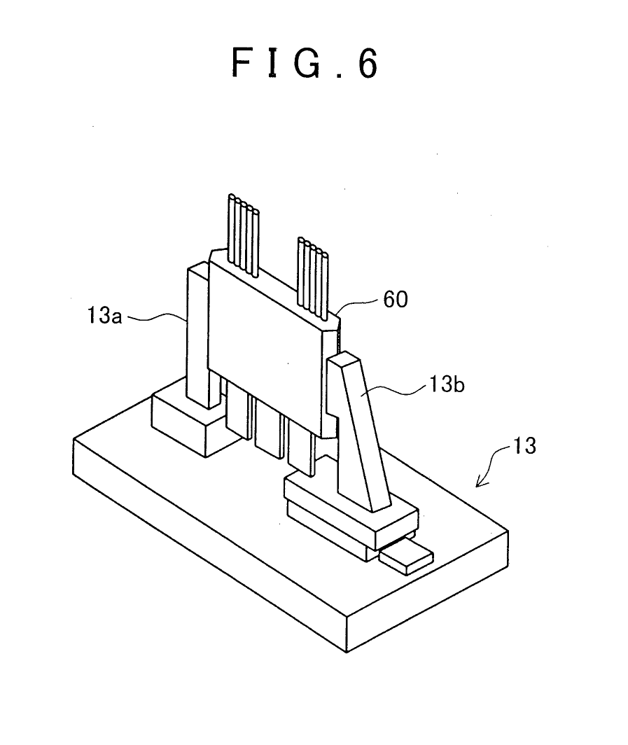

Embodiments, which substantiate a coating apparatus and a coating method according to the invention, are explained below in detail based on the drawings. The coating apparatus according to the embodiment is explained with reference to FIG. 1 to FIG. 6. FIG. 1 is a perspective view showing a rough structure of the coating apparatus according to the embodiment. FIG. 2 is a view roughly showing a coating nozzle and explaining a principle of the coating method. FIG. 3 is a view showing an internal shape of the coating nozzle. FIG. 4 is a sectional view of a center part of the coating nozzle. FIG. 5 is a sectional view of both end parts of the coating nozzle. FIG. 6 is a perspective view roughly showing a work holding part provided in the coating apparatus. In this embodiment, a case is explained where the invention is applied to coating of a power card (a power element module) with thermal grease.

As shown in FIG. 1, a coating apparatus 10 according to this embodiment includes a coating nozzle 20, a cylinder 30, and a moving part 40. The coating apparatus 10 is structured so as to coat a power card 60 (see FIG. 6), serving as an object to be coated, with high-viscosity thermal grease, serving as a coating material, by moving the coating nozzle 20 using the moving part 40 while the coating nozzle 20 discharges the thermal grease. The high-viscosity thermal grease has viscosity of 150 Pa·s or higher, preferably 200 Pa·s or higher, more preferably about 250˜500 Pa·s.

The coating nozzle 20 has a long narrow (flat) discharge port 21, and applies thermal grease widely. In this embodiment, a coating width is set to about 50 mm. each other and fixed to each other by bolts. At the same time, side plates 20c, 20c are mounted on both side surfaces of the coating nozzle 20. The coating nozzle 20 feeds a fixed quantity of thermal grease by using a feed pump 22 that is mounted directly on the coating nozzle 20. The coating nozzle 20 is provided with a pressure sensor (not shown) that measures pressure inside the nozzle. The feed pump 22 and the pressure sensor (not shown) are connected to a control portion 50, and the control portion 50 controls start and stop of rotation of the feed pump 22, the number of revolutions of the feed pump 22, and so on based on information from the pressure sensor (not shown).

The coating nozzle 20 described above is held and fixed to a nozzle holding part 25. The nozzle holding part 25 slides along a rail 12 provided on a base 11. One end of the cylinder 30 is connected to the nozzle holding part 25. The other end of the cylinder 30 is fixed to the base 11 at a predetermined position. Thus, as shown in FIG. 2, the cylinder 30 applies predetermined pressing force F to the coating nozzle 20, which is held and fixed to the nozzle holding part 25, towards the power card 60 that is set at a predetermined position. The cylinder may be an air cylinder or a hydraulic cylinder.

The discharge port 21 of the coating nozzle 20 has a long narrow shape. Therefore, when discharging high-viscosity thermal grease from the coating nozzle 20, a pressure drop in both end parts of the nozzle is larger than a pressure drop in a center part of the nozzle. Therefore, a discharge quantity becomes large in the center part of the nozzle, and a discharge quantity in both end parts of the nozzle becomes small. This means that uniform discharge of the thermal grease in the entire region of the width of the nozzle may not be possible.

Thus, throttle lengths Lc, Le in the center part and both end parts of the discharge port 21 of the coating nozzle 20 are changed. This way, pressure drops in the center part and both end parts inside the coating nozzle 20 are differentiated, and discharge pressure of the thermal grease discharged from the discharge port 21 is made uniform. Specifically, in this embodiment, as shown in FIG. 3 to FIG. 5, the throttle length Le of both end parts is made shorter than the throttle length Lc of the center part (Le<Lc) in nozzle 20 is able to discharge the thermal grease stably and uniformly in a width direction. In FIG. 3, the side plates 20c are omitted.

The base 11, on which the coating nozzle 20 described above is installed, is moved in an upper and lower direction in FIG. 1 by the moving part 40 fixed to a frame 15. The moving part 40 is connected to the control portion 50, and the control portion 50 controls an operation of the moving part 40. In short, the control portion 50 controls an operation of the moving part 40 so that the coating nozzle 20 moves at predetermined speed. The coating apparatus 10 is able to coat the power card 60 with the thermal grease at predetermined coating speed.

Then, the frame 15 is fixed to a base stand (not shown). A work fixing part 13 (see FIG. 6), which holds and fixes the power card 60, is mounted on the base stand. As shown in FIG. 6, the work fixing part 13 includes a fixed claw 13a and a movable claw 13b. After the movable claw 13b is moved to expand an interval between the fixed claw 13a and the movable claw 13b, both side end parts of the power card 60 are sandwiched between the fixed claw 13a and the movable claw 13b, so that the power card 60 is able, to be held and fixed in a standing state (an upright state). The work fixing part 13 is mounted on the coating apparatus 10 at a predetermined position so that the power card 60 to be held and fixed faces the coating nozzle 20.

Next, a coating operation by the coating apparatus 10 is explained. First of all, the power card 60 is set in the work fixing part 13 provided in the coating apparatus 10. To be specific, the movable claw 13b of the work fixing part 13 is moved to expand the interval between the movable claw 13b and the fixed claw 13a, and, in that state, one side end part of the power card 60 is abutted on and held by the fixed claw 13a. Then, the movable claw 13b is moved back so that the other side end part of the power card 60 is abutted on and held by the movable claw 13b. Thus, both sides of the power card 60 are sandwiched between the fixed claw 13a and the movable claw 13b, and held and fixed by the work fixing part 13.

Once the power card 60 is set to the work fixing part 13, the moving part coating nozzle 20 faces the power card 60. In this embodiment, the coating nozzle 20 is arranged near a lower end part of the power card 60 (a position where application of thermal grease begins). Predetermined pressing force F is applied to the coating nozzle 20 in a direction in which the coating nozzle 20 is pressed against the power card 60.

Then, the feed pump 22 operates in accordance with a command from the control portion 50, and thermal grease 70 is discharged from the discharge port 21 of the coating nozzle 20 (see FIG. 2). At this time, the number of revolutions of the feed pump 22 is controlled so that pressure inside the coating nozzle 20 becomes predetermined set pressure, and a fixed quantity of the thermal grease 70 is discharged from the coating nozzle 20 to the power card 60.

Once the thermal grease 70 is discharged from the coating nozzle 20, the coating nozzle 20 is moved upwardly by the moving part 40 at predetermined speed as shown in FIG. 2. Thus, the power card 60 is coated with the thermal grease 70 at predetermined coating speed.

Once the thermal grease 70 is discharged from the coating nozzle 20 to the power card 60, discharge reaction force R is generated as reaction force to discharge pressure. When the discharge reaction force R is larger than pressing force F of the cylinder 30, the coating nozzle 20 is pressed back towards the cylinder 30. Then, the coating nozzle 20 moves in a direction away from the power card 60 (to the right in FIG. 2) to a position where the discharge reaction force R and the pressing force F are balanced with each other, and a fixed gap G is formed between the power card 60 and the coating nozzle 20.

Since the coating nozzle 20 is moved in a state where the above-mentioned gap G is formed, a scraper effect of the nozzle is obtained effectively. As a result, it is possible to coat the power card 60 with high-viscosity thermal grease widely, thinly, and uniformly regardless of waviness and so on of a surface to be coated of the power card 60.

The gap G formed between the power card 60 and the coating nozzle 20 is discharge reaction force R. Therefore, when the pressing force F is fixed, the gap G is changed by changing a magnitude of the discharge reaction force R. For example, by changing at least either a feed rate of the thermal grease 70 to the coating nozzle 20 or moving speed (coating speed) of the coating nozzle 20, a size of the gap G is able to be adjusted.

Specifically, the gap G becomes large by increasing the feed rate of the thermal grease 70 to the coating nozzle 20 (increasing rotation speed of the feed pump 22. On the other hand, the gap G becomes small by reducing the feed rate of the thermal grease 70 to the coating nozzle 20 (reducing rotation speed of the feed pump 22). Similarly, the gap G becomes large by reducing moving speed of the coating nozzle 20. On the other hand, the gap G becomes small by increasing moving speed of the coating nozzle 20. Since appropriate feed rate and moving speed (coating speed) are decided in advance from experiments so that the appropriate gap G is formed in accordance with the thermal grease 70 to be used, it is possible to coat the power card 60 with the thermal grease 70 uniformly with a desired film thickness.

It is also possible to adjust the size of the gap G by changing an opening area of the coating nozzle 20 (changing an opening height of the nozzle because an opening width of the nozzle basically matches a width of the object to be coated). Therefore, the opening area of the coating nozzle 20 may be changed in addition to (or instead of) changing at least either the feed rate of the thermal grease 70 to the coating nozzle 20 or the moving speed (coating speed) of the coating nozzle 20. In a case where the opening area of the coating nozzle 20 is changed, the gap G becomes large by increasing the opening area, and the gap G becomes small by reducing the opening area.

Alternatively, it is possible to adjust the size of the gap G by changing the pressing force F of the cylinder 30. In a case where the pressing force F of the cylinder 30 is changed, the gap G becomes large by reducing the pressing force F, and the gap G becomes small by increasing the pressing force F.

As stated so far, in the coating apparatus 10, it is possible to adjust the gap Therefore, it is possible to coat the power card 60 with the thermal grease 70 uniformly with a desired film thickness.

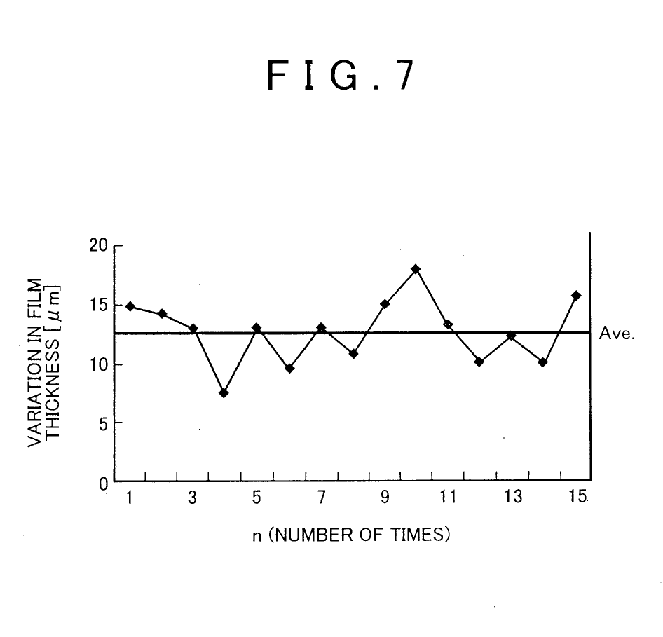

FIG. 7 shows a result of coating of a dummy work with thermal grease by using the coating apparatus 10 under the following conditions. FIG. 7 is a graph showing variation in film thickness. In this test, the dummy work was coated with the thermal grease with viscosity of 250˜500 Pa·s to have a coating film thickness of 30 μm, a coating width of 50 mm, and a coating length of 30 mm. The coating apparatus 10 was set to have a nozzle gap of 0.5 mm, pressing force of 15 N, and coating speed of 7 mm/sec. Under these conditions, the coating test was conducted for 15 times (n=15). As a result, as shown in FIG. 7, an average film thickness (Ave.) became 12.7 μM (maximum 18 μm), and it was confirmed that the high-viscosity thermal grease was applied uniformly with a desired film thickness. Variation in the film thickness is a difference between a thickness of a part with the largest film thickness and a thickness of a part with the smallest film thickness.

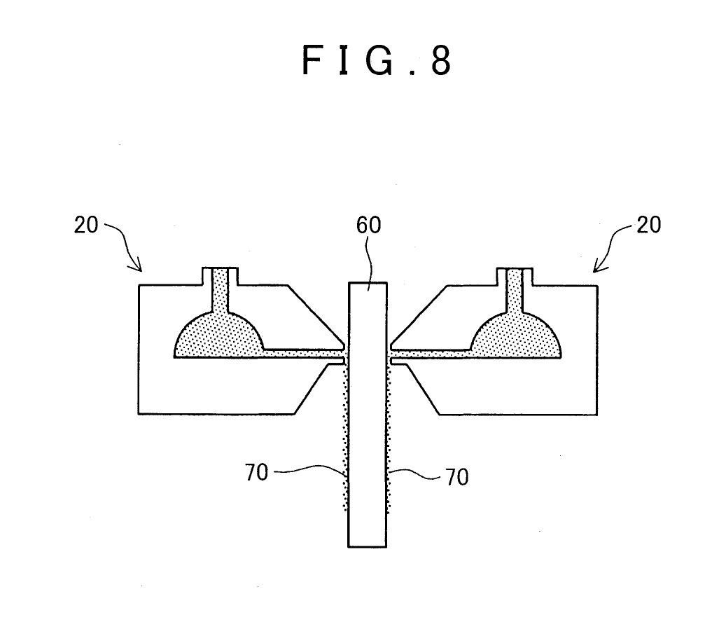

A modified example of a coating apparatus is explained with reference to FIG. 8. FIG. 8 is a view schematically showing a rough structure of a main part of a coating apparatus according to the modified example. In the modified example, two coating nozzles 20 are provided, and the coating nozzles 20, 20 are arranged at positions so as to face each other across a power card 60 that is held and fixed to a work fixing part 13.

Then, in a state where the coating nozzles 20 are pressed against the power card 60 by cylinders 30 provided in the coating nozzles 20, respectively, the coating nozzles 20 coat the power card 60 with thermal grease 70 while the coating nozzles 20 are moved by moving parts 40, respectively. Thus, in the modified example, both surfaces of the power card 60 are coated with the thermal grease 70 simultaneously.

In this modified example, similar effects to those of the foregoing embodiment are obtained, and it is possible to coat the power card 60 with the high-viscosity thermal grease 70 uniformly with a desired film thickness. Moreover, in the modified example, both surfaces of the power card 60 are coated with the thermal grease 70 at once (simultaneously). Therefore, in a case where both surfaces are coated, the number of coating processes is reduced by half, thereby improving a yield.

As explained in detail so far, the coating apparatus 10 according to the embodiment, coating is performed as the thermal grease 70 is discharged to the power card 60 from the coating nozzle 20 while the cylinder 30 provided in the coating nozzle 20 applies the predetermined pressing force F to the coating nozzle 20 towards the object to be coated. At this time, the coating nozzle 20 moves to a position where the discharge reaction force R and the pressing force F are balanced with each other, and a fixed gap G is formed between the power card 60 and the coating nozzle 20. Since the coating nozzle 20 is moved in this state, a scraper effect of the nozzle is obtained effectively, and it is possible to coat the power card 60 with the high-viscosity thermal grease 70 widely, thinly, and uniformly regardless of waviness and so on of a surface to be coated of the power card 60.

In the coating apparatus 10, the cylinder 30 having a rather simple structure is provided in the coating nozzle 20, instead of giving the nozzle a function of scanning an uneven surface while in contact with an object to be coated as in the related art. Therefore, it is possible to coat the power card 60 with the high-viscosity thermal grease 70 widely, thinly, and uniformly, with a small-sized and simple structure.

The foregoing embodiment is just an example, and thus does not limit the invention at all, and various improvements and changes may of course be made without departing from the gist of the invention. For example, in the foregoing embodiment, the cylinder 30 was explained as an example of the pressing mechanism. However, a spring or the like may be used instead of the cylinder. In the foregoing embodiment, the coating nozzle 20 is moved in a vertical direction for coating. However, the coating nozzle 20 may of course be moved in a direction other than the vertical direction (for example, a horizontal direction) for coating.

1. A coating apparatus, comprising:
a flat nozzle that discharges a viscous coating material;
a moving mechanism that moves the flat nozzle, the coating apparatus coating an object to be coated with the coating material while moving the flat nozzle; and
a pressing mechanism that is included in the nozzle and applies predetermined pressing force to the nozzle towards the object to be coated, wherein
the pressing mechanism moves the nozzle in a direction away from the object to be coated to a position where force that presses the nozzle back to the pressing mechanism is balanced with the pressing force, and forms a gap between the object to be coated and the nozzle, the force that presses the nozzle back to the pressing mechanism being generated by discharge reaction force generated when the coating material is discharged from the nozzle to the object to be coated.

2. The coating apparatus according to claim 1, further comprising:
a control device configured to control a feed rate of the coating material to the nozzle and a moving speed of the nozzle, wherein
the control device sets a size of the gap by controlling at least one of the feed rate and the moving speed.

3. The coating apparatus according to claim 2, wherein
the size of the gap is adjusted by changing an opening area of the nozzle.

4. A coating apparatus according to claim 2, wherein
the size of the gap is adjusted by controlling the pressing force of the pressing mechanism.

5. The coating apparatus according to claim 1, wherein
a discharge port of the nozzle is formed so that a throttle length of both end parts of the nozzle becomes shorter than a throttle length of a center part of the nozzle in order to realize uniform discharge pressure of the coating material discharged from the discharge port.

6. A coating method, in which an object to be coated is coated with a viscous coating material while a flat nozzle that discharges the coating material is moved by moving mechanism, the coating method comprising:
forming a gap between the object to be coated and the nozzle by moving the nozzle in a direction away from the object to be coated to a position where force that presses the nozzle back is balanced with a pressing force, while applying predetermined pressing force to the nozzle towards the object to be coated, the force that presses the nozzle back being generated by discharge reaction force generated when the nozzle discharges the coating material to the object to be coated.
